(19) United States
(12) Patent Application Publication
(10) Pub. No.: US 2005/0264762 A1
(43) Pub. Date: Dec. 1, 2005

(54) Method and apparatus to enhance contrast ratio in projection system

(76) Inventor: Hyun-seung Cho, Gwangmyung-si (KR)

Correspondence Address: STANZIONE & KIM, LLP, 919 18TH STREET, N.W., SUITE 440, WASHINGTON, DC, 20006, US

(21) Appl. No.: 11/071,344

(22) Filed: Mar. 4, 2005

(30) Foreign Application Priority Data
May 27, 2004 (KR) 2004-37692

(51) Int. Cl. G03B 21/26

(52) U.S. Cl. 353/30

(57) ABSTRACT

An apparatus to enhance a contrast ratio in a projection system which includes a light emitting device portion to emit light, an illumination optical system to control a property of the light emitted from the light emitting device portion, a panel portion to project the light incident from the illumination optical system, an image driving portion to correct contrast with respect to an input image signal and to output the corrected image signal to the panel portion, and extracting a mean level value of an image signal to be displayed within a predetermined period to correct a signal transfer property, and a light emission control portion to control light emission time rate of the light emitting device portion by comparing the mean level value of an image signal extracted by the image driving portion with a preset reference value.

### CROSS-REFERENCE TO RELATED APPLICATIONS

This application claims the priority of Korean Patent Application No. 10-2004-0037692, filed on May 27, 2004, in the Korean Intellectual Property Office, the disclosure of which is incorporated herein in its entirety by reference.

### BACKGROUND OF THE INVENTION

1. Field of the Invention

The present general inventive concept relates to a projection system, and more particularly, to a method and apparatus to enhance a contrast ratio in a projection system by which a high contrast ratio is stably obtained using an LED light source in the projection system.

2. Description of the Related Art

In general, a projection system adopting a liquid crystal display (LCD) projects an image with light emitted from an illumination optical system onto a screen using a polarization panel and a projection lens to reproduce an image.

However, the contrast ratio of an LCD panel on which an image is displayed is quite lower than that of other display apparatuses such as a cathode ray tube. When a polarization degree of a polarization panel arranged between the LCD panel and the projection lens is over 99.5%, light is not completely shielded. Thus, a black level of an image reproduced on the screen after passing through the LCD panel and the polarization panel does not become a complete black level so that the contrast ratio of an image reproduced by the LCD projection system is quite lowered.

To solve this problem, Korean Patent Publication No. 2001-0011567 discloses a projection system. Referring to FIG. 1, a conventional illumination optical system includes a light source 10 emitting a divergent light using a high pressure mercury lamp as a light source, a relay lens 11 making an optical property of the light emitted from the light source 10 using a total reflection property uniform and reducing an angle of divergence of the divergent light, a collimating lens 12 changing the light passing through the relay lens 11 to a parallel beam, a dichroic mirror 13 separating the parallel beam into three primary colors signal components R, G, and B and changing optical paths thereof, and a first polarization panel 14 polarizing each color signal component from the dichroic mirror 13 to be incident on an LCD panel 15.

An image driving portion 16 provides an input image signal to the LCD panel 15 by performing a predetermined signal processing with respect to the image signal, maintains constant brightness of an image displayed on the LCD panel 15 by performing an auto brightness limited (ABL) control function, and provides an ABL control signal to an optical shutter control portion 21 according to an mean level of the image signal.

The optical shutter control portion 21 closes an optical shutter 22 when the ABL control signal input from the image driving portion 16 is in a high level and opens the optical shutter 22 when the ABL control signal is in a low level. That is, the optical shutter control portion 21 applies a shutter control signal inversely proportional to the level of the ABL control signal to the optical shutter 22 so that bright light of the overall LCD panel 15 is appropriately shielded to greatly enhance a contrast ratio, and dark light is transmitted to maintain the contrast ratio.

The conventional projection system as shown in FIG. 1 has an effect of enhancing a contrast ratio by adopting the high pressure mercury light source and the optical shutter. The high pressure mercury lamp emits three portions of ultraviolet rays, visible light, and infrared rays. A wavelength range needed by the projection system is a visible light wavelength range. An ultraviolet wavelength range deteriorates performance of optical parts of a system, a plastic lens and other optical parts, a polarization prism, and an LCD. Although the IR wavelength range does not directly damage parts and optical parts, when it is absorbed by an optical part, the temperature of the optical parts increases so that the optical parts do not exhibit a normal performance.

In particular, in the conventional projection system, since an optical shutter is used, the number of optical parts is increased. Since an LCD is used as the optical shutter, a response speed of the optical shutter must be very fast. In addition, the performance of the optical shutter can be deteriorated by the light in the ultraviolet wavelength range emitted from the lamp.

### SUMMARY OF THE INVENTION

To solve the above and/or other problems, the present general inventive concept provides a method and apparatus to enhance a contrast ratio in a projection system by which a high contrast ratio is stably obtained by controlling the amount of light of an LED light source in the projection system.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are be achieved by providing an apparatus to enhance a contrast ratio in a projection system comprising a light emitting device portion to emit light, an illumination optical system to control a property of the light emitted from the light emitting device portion, a panel portion to project the light incident from the illumination optical system, an image driving portion to correct contrast with respect to an input image signal and to output the corrected image signal to the panel portion, and to extract a mean level value of an image signal to be displayed within a predetermined period to correct a signal transfer property, and a light emission control portion to control light emission time rate of the light emitting device portion by comparing the mean level value of an image signal extracted by the image driving portion with a preset reference value.

The image driving portion may comprise a scaler portion to up and down sample a digital image signal into a signal suitable for resolution of the panel portion, and a contrast correction portion to obtain a mean value in a particular area with respect to an luminance value of the image signal scaled by the scaler portion and correct a gray scale of the image signal according to the mean value.

The light emission control portion may comprise a PWM control amount calculation portion to calculate a PWM control amount by comparing the mean level value of an image signal obtained by the image driving portion with the preset reference value, and a PWM control portion to control a ratio of light emission time rate of a PWM according to the PWM control amount calculated by the PWM control amount calculation portion.

The foregoing and/or other aspects and advantages of the present general inventive concept may also be achieved by providing a method of enhancing a contrast ratio in a light emission driving type projection system, the method comprising extracting a mean level of R, G, and B image signals to be displayed within a predetermined period, comparing the mean level with respect to the respective R, G, and B image signals extracted in the extracting of a mean level of R, G, and B image signals with a preset reference level, and controlling a light emission control amount according to a level signal based on a result value compared in the comparing of the mean level with respect to the respective R, G, and B image signals with a preset reference level.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a conventional apparatus for enhancing a contrast ratio in a projection system;

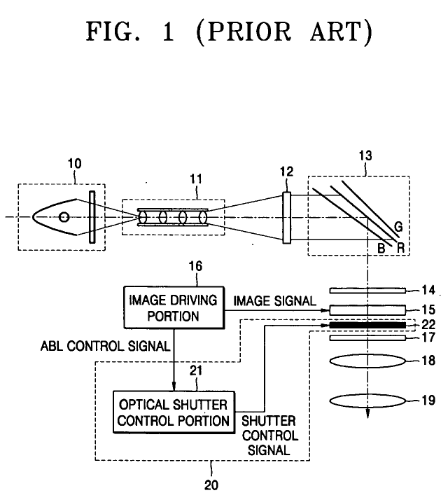

FIG. 2 is a view illustrating the configuration of an apparatus to enhance a contrast ratio in a projection system according to an embodiment of the present general inventive concept;

FIG. 3 is a block diagram illustrating the image driving portion and the LED control portion of FIG. 2;

FIGS. 4A through 4C are graphs explaining in detail the contrast correction portion of FIG. 3; and

FIGS. 5A through 5C are PWM waveform diagrams corresponding to the PWM control amount calculated by the PWM control amount calculation portion of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

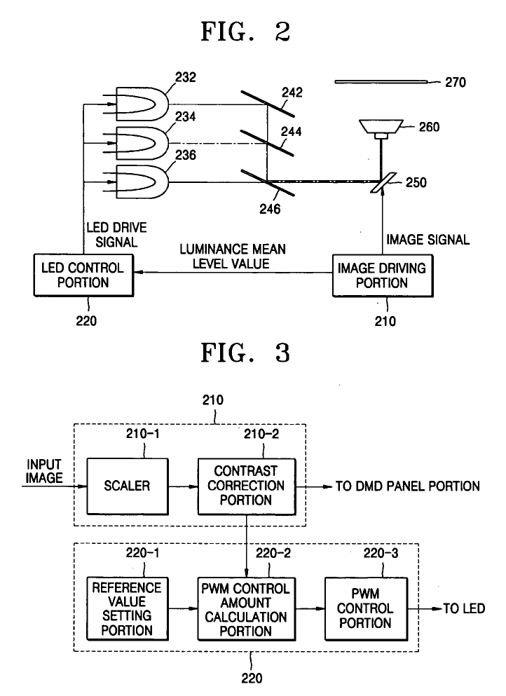

FIG. 2 shows the configuration of an apparatus to enhance a contrast ratio in a projection system according to an embodiment of the present general inventive concept. Referring to FIG. 2, an image driving portion 210 converts an input image signal into a drive control signal by a predetermined signal process and provides the converted drive control signal to a digital micromirror device (DMD) panel 250 and stably maintains brightness of an image displayed on the DMD panel 250 by performing an auto brightness limited (ABL) control function. The image driving portion 210 obtains a luminance mean level value of each of R, G, and B image signals to be displayed within a predetermined period and performs a contrast correction function to change a signal transfer function according to the mean level value of each of the R, G, and B image signals.

An LED control portion 220 compares the luminance mean level value of each of the R, G, and B image signals applied from the image driving portion 210 and a preset reference value, and generates an LED driving control signal to increase the LED light emission time rate when the luminance mean level value is higher than the reference value, and an LED driving control signal to decrease the LED light emission time rate when the luminance mean level value is lower than the reference value. That is, the LED control portion 220 makes an image on a bright screen brighter by increasing the light emission amount of the LEDs 232, 234, and 236 when the luminance mean level value of an input image signal is higher than the reference value, and an image on a dark screen darker by decreasing the light emission amount of the LEDs 232, 234, and 236 when the luminance mean level value of an input image signal is lower than the reference value. As a result, the LED control portion 220 stably embodies a high contrast ratio by controlling the light emission amount of the LEDs by pulse width modulation (PWM).

An illumination optical system includes an R LED, a G LED, and a B LED 232, 234, and 236, respectively, and dichroic mirrors 242, 244, and 246. The R LED, the G LED, and the B LED 232, 234, and 236 emit corresponding lights according to an LED driving signal in PWM format generated from the LED control portion 220. The dichroic mirrors 242, 244, and 246 change paths of R, G, and B parallel beams generated from the R LED, the G LED, and the B LED 232, 234, and 236, respectively.

The DMD panel 250 alters an angle of light incident from the dichroic mirrors 242, 244, and 246. In another embodiment, the DMD panel can be replaced with an LCD panel. A projection optical system 260 projects light reflected from the DMD panel 250 onto a screen 270.

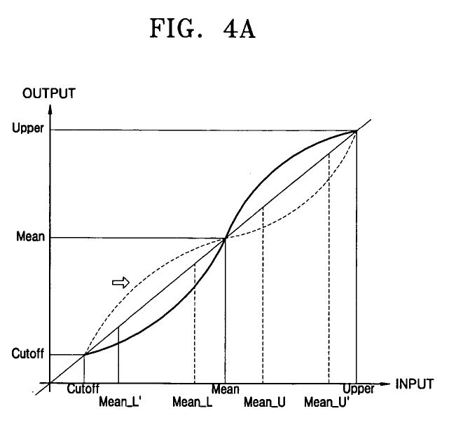

FIG. 3 shows the image driving portion 210 and the LED control portion 220 of FIG. 2. Referring to FIG. 3, the image driving portion 210 includes a scaler portion 210-1 and a contrast correction portion 210-2 while the LED control portion 220 includes a reference value setting portion 220-1, a PWM control amount calculation portion 220-2 and a PWM control portion 200-3.

First, one of R/G/B image signals, an RF signal, or a CVBS (composite video base-band signal) signal generated from a PC, DTV, or RF tuner is input. The scaler portion 210-1 samples one of the R/G/B image signals, the RF signal, or the CVBS signal according to a sampling clock generated from a system control portion (not shown) and converts the sampled signal into a digital image signal, and up/down samples the digital R, G, and B image signals input according to a sampling clock into signals suitable for the resolution of a panel.

The contrast correction portion 210-2 obtains a mean value of luminance values of image signals that is signal-processed by the scaler portion 210-1 and corrects a gray scale of the image signal according to the luminance mean value. For example, when a certain portion on a bright screen is dark, the gray scale is changed to enhance a contrast ratio with respect to the certain portion.

The PWM control amount calculation portion 220-2 compares the luminance mean level value of each of the R, G, and B image signals obtained from the contrast correction portion 210-2 and a reference value read from the reference value setting portion 220-1 and calculates a PWM control amount corresponding to the amount of light emission per time (rate) corresponding to the amount of light emission per time of the PWM. The PWM control portion 220-3 controls the LED light emission time rate according to the PWM control amount calculated from the PWM control amount calculation portion 220-2.

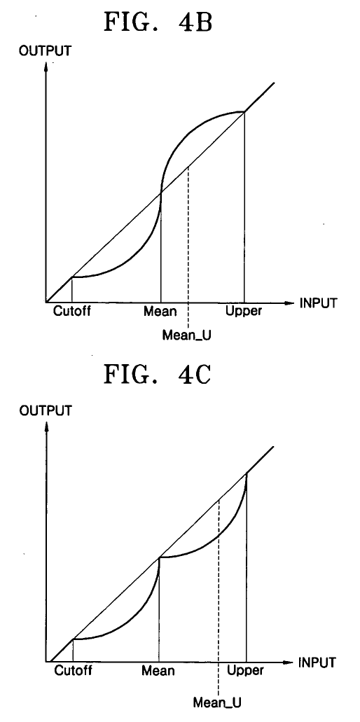

FIGS. 4A through 4C are graphs explaining in detail the contrast correction portion 210-2 of FIG. 3. Referring first to FIG. 4A, in a process of correcting contrast of an input image, a mean value “Mean” between areas “Cutoff” and “Upper” to increase contrast with respect to luminance of an input image signal is calculated. The luminance value of the input image signal is divided into an upper area and a lower area with respect to the mean value “Mean” and a luminance mean value with respect to each of the two areas is obtained. That is, 1) a mean value Mean_U between a mean area and an upper area and 2) a mean value Mean_L between the mean area and a cutoff area.

The signal transfer functions are determined according to the mean values Mean_U and Mean_L. That is, in the upper area, when the mean value Mean_U approaches the mean value Mean, an output curve is determined to bulge upward and, when the mean value Mean_U approaches the upper area Upper, an output curve is determined to bulge downward. In the lower area, when the mean value Mean_L approaches the cutoff area, an output curve is determined to bulge upward and, when the mean value Mean_L approaches the mean value, an output curve is determined to bulge downward.

In another embodiment, in the lower area, the signal transfer function can be formed to always bulge downward as shown in FIG. 4B and, in the upper area, the shape of the signal transfer function varies according to the position of the mean value Mean_U as shown in FIG. 4C.

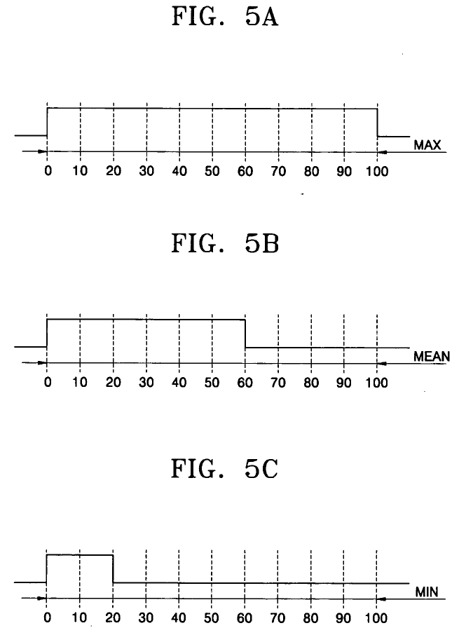

FIGS. 5A through 5C are PWM waveform diagrams corresponding to the PWM control amount calculated by the PWM control amount calculation portion of FIG. 3. Referring to FIG. 5A, when the mean level value of an image signal is greater than the reference value, the LED light emission time rate of the PWM is set to its maximum (100%) so that an image on a bright screen is made brighter. Referring to FIG. 5B, when the mean level value of the image signal is the same as the reference value, the LED light emission time rate of the PWM is set to 60%. Referring to FIG. 5C, when the mean level value of the image signal is less than the reference value, the LED light emission time rate of the PWM is set to its minimum (20%) so that an image on a dark screen is made darker.

As described above, according to the present general inventive concept, by controlling an LED light amount that is a light source of an illumination optical system in a projection system, a contrast ratio can be stably maintained without adopting a high pressure mercury light source and an optical shutter, as in conventional projection systems.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to enhance a contrast ratio in a projection system comprising:
a light emitting device portion to emit light:
an illumination optical system to control a property of the light emitted from the light emitting device portion;
a panel portion to project the light incident from the illumination optical system;
an image driving portion to correct contrast with respect to an input image signal and output the corrected image signal to the panel portion, and to extract a mean level value of an image signal to be displayed within a predetermined period to correct a signal transfer property; and
a light emission control portion to control light emission time rate of the light emitting device portion by comparing the mean level value of an image signal extracted by the image driving portion with a preset reference value.

2. The apparatus as claimed in claim 1, wherein the image driving portion comprises:
a scaler portion to up and down sample a digital image signal into a signal suitable for resolution of the panel portion; and
a contrast correction portion to obtain a mean value in a particular area with respect to a luminance value of the image signal scaled by the scaler portion and to correct a gray scale of the image signal according to the mean value.

3. The apparatus as claimed in claim 1, wherein the light emission control portion comprises:
a PWM control amount calculation portion to calculate a PWM control amount by comparing the mean level value of an image signal obtained by the image driving portion with the preset reference value; and
a PWM control portion to control a ratio of light emission time rate of a PWM according to the PWM control amount calculated by the PWM control amount calculation portion.

4. The apparatus as claimed in claim 1, wherein the panel portion is a digital micromirror device.

5. The apparatus as claimed in claim 1, wherein the panel portion is a LCD panel.

6. The apparatus as claimed in claim 1, wherein the light emitting device portion includes light emitting diodes emitting light with respect to R, G, and B image signals.

7. The apparatus as claimed in claim 3, wherein when the mean level value of the image signal is the same as the reference value, the LED light emission time rate of the PWM is set to 60%. Referring to FIG. 5C, when the mean level value of the image signal is less than the reference value, the LED light emission time rate of the PWM is set to its minimum (20%) so that an image on a dark screen is made darker

8. An apparatus to enhance a contrast ratio in a projection system, comprising:
an illumination optical system to emit R, G and B light beams;
an image driving unit to extract a luminance mean level value of each of R, G and B image signals to be displayed within a predetermined time period and to change a signal transfer function according to the luminance mean level value each of the R, G and B image signals;
an illumination control portion to generate an illumination driving control signal to control the light emission time rate by comparing the luminance mean level values with a preset reference value.

9. The apparatus as claimed in claim 8, wherein the illumination optical system comprises:
R, G and B LEDs to emit the R, G and B light beams; and
a dichroic mirror for each of the R, G and B LEDs to change paths of the R, G and B light beams.

10. The apparatus as claimed in claim 8, wherein the illumination driving control signal is generated by the illumination control portion in a pulse width modulation format.

11. A light projection system, comprising:
an illumination optical system to emit R,G and B light beams;
a light altering panel to alter and reflect the light beams;
a projection optical system to project the reflected light onto a screen;
an image driving portion to obtain mean level values of each of R, G and B image signals to be displayed within a predetermined time period and to change a signal transfer function according to the mean level value of each of the R, G and B image signals; and
an illumination control unit to compare the luminance mean level value of each of the R, G and B image signals to a preset reference value, and to generate an illumination control signal to control the light emission time rate of the illumination optical system.

12. The light projection system as claimed in claim 11, wherein the control signal increases the illumination light emission time rate when the luminance mean level value is higher than the reference value, and decreases the illumination light emission time rate when the luminance mean level value is lower than the reference value.

13. A method of enhancing a contrast ratio in a light emission driving type projection system, the method comprising:
extracting a mean level of R, G, and B image signals to be displayed within a predetermined period;
comparing the mean level with respect to the respective R, G, and B image signals extracted in the extracting of a mean level of R, G, and B image signals with a preset reference level; and
controlling a light emission control amount according to a level signal based on a result value compared in the comparing of the mean level with respect to the respective R, G, and B image signals with a preset reference level.

14. The method as claimed in claim 13, wherein the controlling of a light emission control amount according to a level signal is an operation in which a ratio of a light emission time rate is controlled according to a comparison result between the mean level of the image signal and the preset reference level.

15. The method as claimed in claim 13, wherein, in the controlling of a light emission control amount according to a level signal, when the mean level of the image signal is higher than the reference level, a light emission amount is increased and, when the mean level of the image signal is lower than the reference level, the light emission amount is decreased.

16. The method as claimed in claim 13, further comprising changing a signal transfer function according to the mean level of the image signals.

17. A method of stably maintaining a contrast ratio of an illumination optical system, comprising:
obtaining a luminance mean level value of R, G and B image signals to be displayed within a predetermined time period; and
controlling a light emission amount based on a relationship between the luminance mean level values of each of the R, G and B image signals and a preset reference value.

18. The method as claimed in claim 17, wherein the controlling of a light emission amount comprises increasing a light emission amount when the mean level of the image signal is higher than the reference level and decreasing a light emission amount when the mean level of the image signal is lower than the reference level.

19. The method as claimed in claim 17, further comprising changing a signal transfer function according to the mean level value of the image signals.

20. The apparatus as claimed in claim 18, wherein controlling the light emission amount is performed by pulse width modulation.
